(19) United States
(12) Patent Application Publication
(10) Pub. No.: US 2004/0158738 A1
(43) Pub. Date: Aug. 12, 2004

(54) Security management device and security management method

(75) Inventor: Satoru Tanaka, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/762,330

(22) Filed: Jan. 23, 2004

(30) Foreign Application Priority Data
Jan. 30, 2003 (JP) 2003-022630

(51) Int. Cl. H04L 9/00

(52) U.S. Cl. 713/200

(57) ABSTRACT

To provide a security management device, a security management method, a security management program and a security management system that are capable of ensuring a desired security while scheming to save a labor for the security management by the security management device performing access control of a terminal in accordance with a security level of the terminal and prompting it to do security setting. Whether or not a security level reaches a predetermined level is judged by detecting the security level of a terminal from an access pattern, and, in the case of judging that the security level of the terminal does not reach the predetermined level, an access permission range of the terminal is changed.

### BACKGROUND OF THE INVENTION

The invention relates to a security management method of and a security management program for restricting an access of a terminal in accordance with a security condition of each terminal connected to a network.

In a network such as a LAN, etc., a method of controlling communications of terminals having specified addresses by access control functions of a gateway (including a firewall), a router and a layer-3 switch in order not to have an unlawful access from each of the terminals, has hitherto been utilized as a method of enhancing a property of security.

Computers have been spread widely over the recent years, and, if given as in an enterprise, individual employees have terminals for exclusive use, wherein it is generally practiced that the network is configured to enable E-mails, a printer, etc. to be utilized from on these terminals.

Hence, there increases an opportunity for changing the terminals that connect to the network such as moving, extending the terminals and so forth as the members of staff shift in their positions and rise in their number.

Further, an operation of connecting the terminal to the network is daily conducted such as a case where a mobile terminal (a notebook model PC, etc.) is brought out of an office and utilized for a presentation, etc. and also utilized in the office by connecting this mobile terminal to the network, a case where the mobile terminal is carried back home for working, and the rest of work continues by connecting this terminal again to the in-office network, and so on.

Thus, if the user is able to unrestrictedly connect the terminal, there was a possibility where in case a terminal infected by a virus because of a low security level such as a virus definition file being old connects to the network, the network security might be threatened by demolition of data in such a way that the terminal gains, e.g., an unlawful access to somewhere outside the in-office network or an access to other computers in the in-office network.

In the case of utilizing the terminal by establishing the connection to the network at a user's level, however, it must be too laborious of security management and was not realistic that a network administrator checks a security condition of every terminal each time.

### SUMMARY OF THE INVENTION

The invention was devised in view of these problems inherent in the prior arts. Namely, an object of the invention is to provide a technology of ensuring a desired security while scheming to save the labor for the security management in such a way that a security management device performs access control of a terminal in accordance with a security level of the terminal and prompting it to do security setting.

The invention adopts the following means in order to solve the problems

In a security management device, a security management method, a security management program and a security management system of the invention, a security level of a terminal is detected, a judgement is made by comparing the security level of the terminal with a predetermined level, and, in the case of judging that the security level of the terminal does not reach the predetermined level, an access permission range of the terminal is restricted.

Owing to this, the invention enables the access control of the terminal in accordance with the security level of the terminal, enables the terminal to do the security setting by making the terminal have an access to a specified device such as a security setting guide server, etc., and enables a desired security to be ensured while scheming to save a labor for the security management.

<Readable-by-Computer Recording Medium>

The invention may be a recording medium recorded with the program readably by a computer. Then, the computer is made to read and execute the program on this recording medium, thereby making it possible to provide functions thereof.

Herein, the readable-by-computer recording medium connotes recording mediums capable of storing information such as data, programs, etc. electrically, magnetically, optically and mechanically or by chemical action, which can be read from the computer. What is demountable out of the computer among those recording mediums may be, e.g., a flexible disk, a magneto-optic disk, a CD-ROM, a CD-R/W, a DVD, a DAT, an 8 mm tape, a memory card, etc.

Further, there are a hard disk, a ROM (Read Only Memory) as recording mediums fixed to the computer.

### BRIEF DESCRIPTION OF THE DRAWINGS

FIG. 1 is A diagram showing an example of a network architecture including a security management device.

FIG. 2 is a block diagram showing an architecture of the security management device.

FIG. 3 is an explanatory diagram showing a security management procedure.

FIG. 4 is a display example of a screen for guiding setting.

FIG. 5 is a block diagram showing an architecture of the security management device in a modified example 1.

FIG. 6 is a block diagram showing an architecture of the security management device in an embodiment 2.

FIG. 7 is a diagram of an architecture of the network in the embodiment 2.

### DETAILED DESCRIPTION OF THE PPREFERRED EMBODIMENT

### Embodiment 1

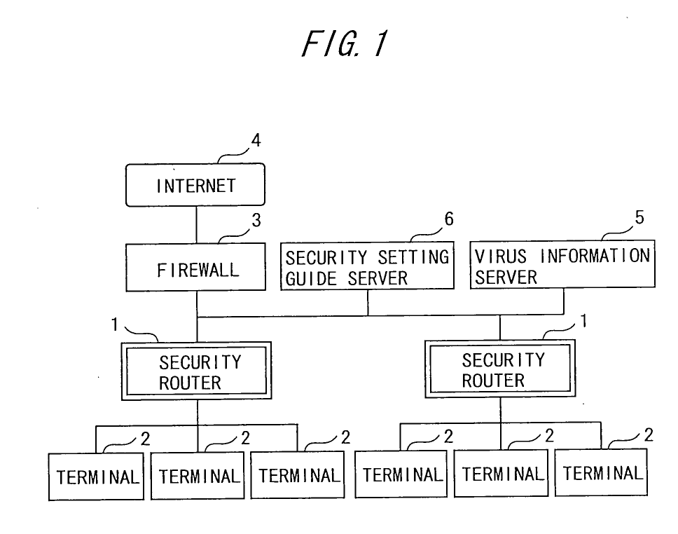

A security management device according to an embodiment 1 of the invention will be explained based on the drawings in FIGS. 1 to 5.

<Outline of Architecture>

FIG. 1 is a diagram showing an example of a network architecture provided with the security management device in the embodiment.

A security management device 1 in the embodiment is a so-called router, to which plurality of terminals (apparatuses) 2 are connected, for performing routing of data transmitted from the respective terminals. For example, the security management device 1, in the case of accepting a request for an access to a server on the Internet from the terminal 2, sends the access request to the server (unillustrated) on an Internet 4 via a firewall 3. Then, in the case of receiving a response from the server, the security management device 1 transfers this response to the terminal. Note that there are provided a plurality of security management devices 1 on a domain basis.

This security management device 1 may be a dedicated electronic appliance constructed of electronic circuits (hardware) designed exclusively as a security detection unit, a judging unit and an access control unit which will be described in detail later on, and may also be a device wherein an arithmetic processing unit constructed of a CPU, a memory, etc. executes a security management program of the invention, thereby softwarewise actualizing functions of the respective units.

Moreover, the network in the embodiment includes a virus information server 5 having a virus definition file for specifying computer viruses, and a security setting guide server 6 for guiding the terminal to reach a predetermined security level.

The security management device 1 detects security information of the terminal 2, judges whether or not a security level of this terminal 2 reaches the predetermined level, and, in a case where there is the access request from the terminal that does not yet reach this level,.has the terminal 2 connected to the security setting guide server 6.

In response to this, the security setting guide server 6 guides so that the terminal 2 comes to meet the predetermined level. For instance, in case it is judged that the virus definition file of the terminal 2 is old and the security level is low, the security setting guide server 6 guides the terminal 2 to access the virus information serve 5 and to acquire an updated virus definition file.

Thus, in the embodiment, an access permission range of the terminal judged to be low of the security level is restricted to the security setting guide server 6 and to the virus information server 5, it is not permitted to access other computers till the predetermined security level is met, and therefore a spread of damages can be prevented even if the terminal having a low security level is infected by the virus. Further, in the embodiment, in a case where the low security level terminal 2 is prompted to improve the security level and accesses other computer, this means that it has invariably reached the predetermined level, and hence the desired security can be ensured even if a network administrator does not confirm the security level each time.

<Security Management Device>

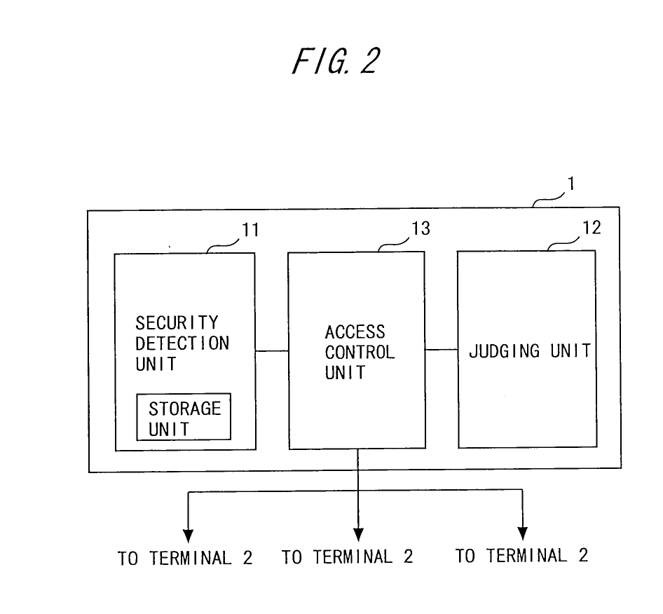

FIG. 2 is a block diagram showing an architecture of the security management device 1.

As shown in the same Figure, the security management device 1 includes a security detection unit 11, a judging unit 12 and an access control unit 13.

The security detection unit 11 detects a security level of the terminal 2 from an access pattern. For instance, whether or not the terminal 2 accesses at a predetermined interval the server 5 having the virus definition file, is detected as an access pattern. The security detection unit 11 has a storage unit (memory) and has it stored with a result of the detection.

The judging unit 12 refers to the memory and thus judges whether or not the security level detected by the security detection unit 11 reaches the predetermined level.

The access control unit 13 has a function of selecting a communication route of the terminal 2 and, in case the judging unit 12 judges that the security level of the terminal 2 does not yet reach the predetermined level, changes the access permission range of the terminal 2. For example, an access destination of the terminal is changed to a specified server.

<Security Management Procedure>

A security management procedure (a security management method) by the security management device will be explained next.

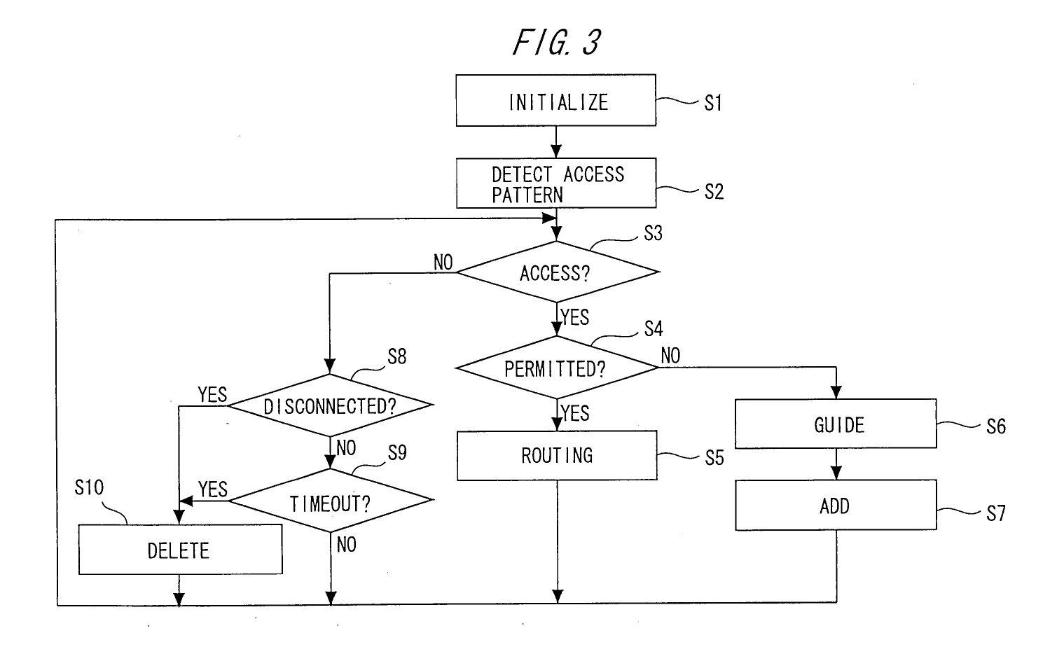

FIG. 3 is an explanatory diagram showing this security management procedure.

The security management device 1, upon a start-up, at first deletes (initializes) all the detection results in the memory of the security detection unit 11 (step 1 which will hereinafter be abbreviated such as S1).

Next, the security detection unit 11 of the security management device 1 detects a security level of the connected terminal, i.e., detects whether it has accessed at the predetermined interval the virus information server 5, and stores the memory with it (S2). This detection may be made by reading a log (a record about when and where it has accessed) stored on each terminal 2 and reading an update time of the virus definition file, or by reading a log (a record about which terminal has accessed and when it has accessed) stored on the virus information server 5.

In case there is an access from the terminal 2, the judging unit 12 refers to the memory and thus judges whether or not this terminal 2 reaches the predetermined security level, viz., judges whether or not it is an object for the access permission (S3, S4).

In case the terminal 2 is judged to be the object for the access permission, the access control unit 13 sets all the computers as the access permission range of this terminal 2, and performs the routing for any access to whichever computer (S5).

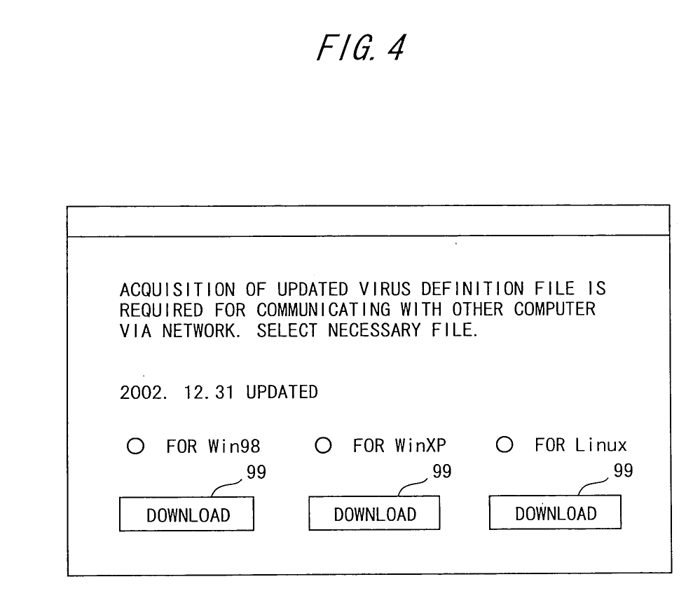

While on the other hand, in the case of judging in step 4 that it is not the object for the access permission, the access control unit 13 restricts the access permission range of the terminal 2 to the security setting guide server 6 and to the virus information server 5, and makes the terminal have an access at first to the server 6 (S6). The security setting guide server 6 causes the connected terminal 2 to display a screen (an HTML-based Web page, etc.) for guiding the setting about the security. FIG. 4 is a display example of the screen for guiding this setting. According to the screen, a user selects a button 99 to a virus definition file required for the in-use terminal 2. Upon a selection of the button 99, the terminal 2 connects to the virus information server 5 to which this button 99 is linked, and acquires the selected virus definition file. This enables the terminal 2 to specify and exterminate a virus by referring to this updated virus definition file on the occasion of executing anti-virus software, and to cope with a virus generated of late. Namely, the security level is improved.

In the case of detecting that this terminal has accessed the virus information server 5, the security detection unit 11 adds the terminal 2 as an object for the permission to the memory (S7).

Thereafter, returning to step 3, there is a wait till the access occurs.

During this wait, in case there is a terminal 2 disconnected from the network, the security detection unit 11 deletes information on this terminal 2 from the memory (S8, S10). Further, the security detection unit 11 deletes, from the memory, pieces of information with an elapse of time equal to or longer than a predetermined time (24 hours in this example) since they were stored on the memory (S9, S10).

As described above, according to the embodiment, in case the security level of the terminal 2 does not reach the predetermined level, the access permission range of the terminal 2 is changed, it is made to access the security setting guide server 6 and to the virus information server 5 and is prompted to improve the security level, and it therefore follows that the desired security is ensured even if the network administrator does not confirm the security level of the terminal 2 connected to the network each time.

Note that the judgement as to the security level may be made based on, without being limited to the interval of accessing the virus information server, whether an unnecessary port is closed or not, whether programs and scripts such as JAVA (registered trademark), ActiveX (registered trademark), etc. are downloaded and executable or not, whether or not it responds to a specified command such as Ping, etc., and so forth.

The setting guide server 6 may, without being limited to the guide to the virus information server 5, set the security, and may also set the security by sending an applet for setting the security to the terminal 2 and causing the terminal 2 to execute this applet. Note that this security setting is a setting as to, in addition to updating the virus definition file and the anti-virus software, whether a predetermined port is closed or not, whether or not the predetermined program and script are downloaded and executed, whether or not it responds to the specified command such as Ping, etc., and so forth.

Further, the detection of the security level may also be made in a way that executes a program for an inspection on the terminal 2 and stores a storage unit with a result of the detection. The storage unit storing this detection result may be in the security management device 1 and may also be in a device accessible from the security management device 1, such as the terminal 2, the security setting guide server 6, the virus information server 5, etc.

### MODIFIED EXAMPLE 1

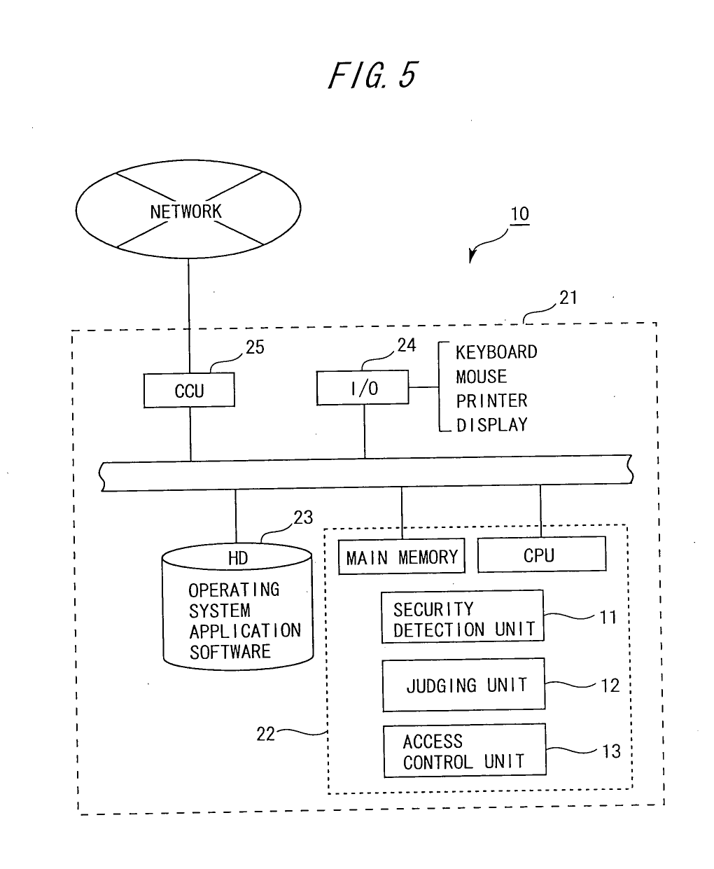

FIG. 5 shows an example in which the security management device is actualized by a general-purpose computer.

As shown in the same Figure, a security management device 10 is a general computer including, within a main body 21, an arithmetic processing unit 22 constructed of a CPU (central processing unit), a main memory, etc., a storage device 23 stored with data and software (security management device, etc.) for the arithmetic process, an input/output unit 24, a communication control device (CCU: Communication Control Unit) 25, etc.

The security management device 10 reads and executes a security management program stored on the storage device 23, thereby actualizing the functions of the security detection unit 11, the judging unit 12 and the access control unit 13. At this time, the security management device 10, in the same way as in the embodiment, executes the respective steps shown in FIG. 3.

This enables the security management device 10 in the example to ensure the desired security in a way that schemes to save a labor for the security management by the network administrator in the same way as in the embodiment.

### Embodiment 2

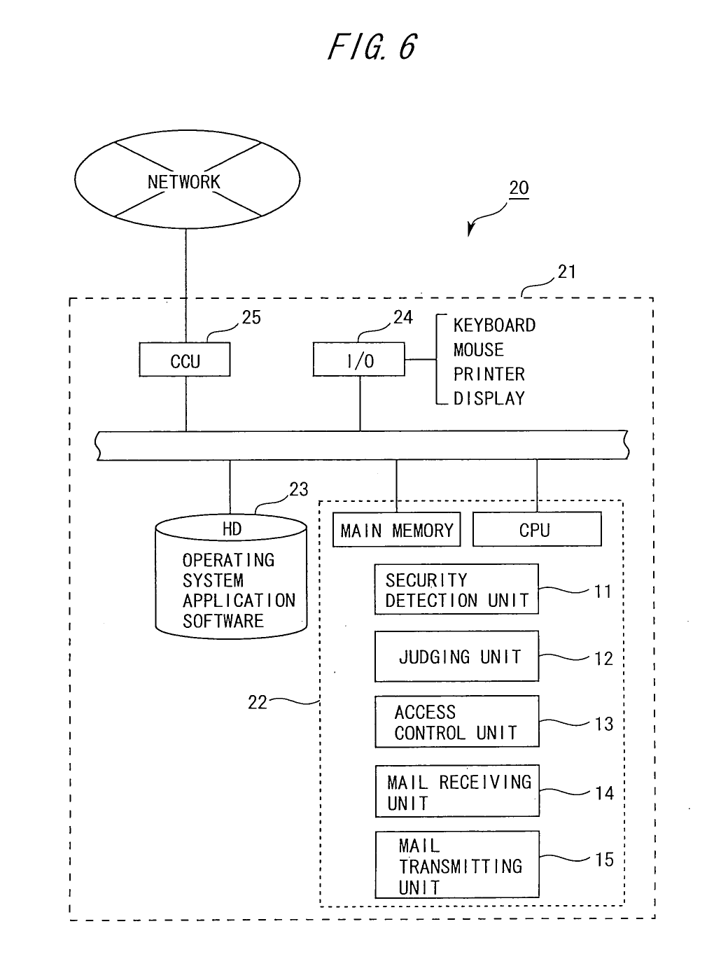

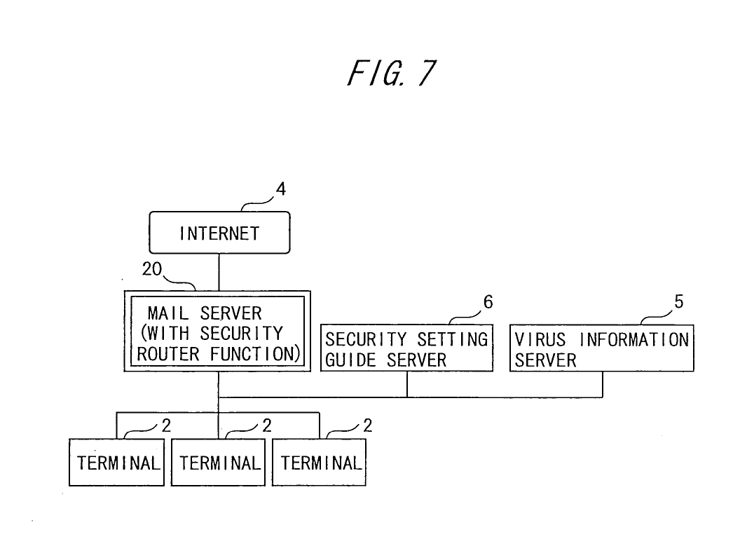

FIG. 6 is a block diagram showing an architecture in an embodiment 2 of the invention, and FIG. 7 is a diagram of an architecture of a network including the security management device in the embodiment. A mail server (security management device) 20 in the embodiment is different from the modified example 1 in terms of having a mail server function, and other configurations are approximately the same. Note that the same components are marked with the same symbols, and thus the repetitive explanations are omitted.

The mail server 20, as a function of a mail receiving unit 14, receives an E-mail addressed to each of the terminals 2 via the Internet, and provides the E-mail to the connected terminal 2.

Further, the mail server 20, as a function of a mail transmitting unit 15, receives the transmitted mail from each terminal and transmits it to each computer as its destination.

The mail server 20 in the embodiment, if within a predetermined time since the terminal 2 accessed the virus information server 5, transmits or receives the mail, and, if beyond the predetermined time, has the terminal connected to the security setting guide server 6.

This enables the mail server 20 in the example to ensure the desired security in a way that schemes to save the labor for the security management by the network administrator in the same way as in the embodiment, and eliminates bringing about a damage by the virus through the mail owing to preventing the mail from being transmitted and received unless a new virus definition file is acquired even if the terminal 2 having a low security level is connected.

The embodiment has exemplified the mail server, however, the security management device of the invention may also be, without being limited to this, a proxy server, an NFC, a home gateway, etc. as far as it includes the security detection unit, the judging unit and the access control unit.

### Other Embodiments

The invention is not confined to only the illustrative examples and can have, as a matter of course, additions of a variety of changes within the range that does not deviated from the gist of the invention.

For instance, as the embodiment of the security management device 10, the exemplification was given, wherein the access permission range is set, as an initial setting, to the whole range, and the access permission range is, when the security level of the terminal does not reach the predetermined level, changed to the security setting guide server 6 and to the virus information server 5.

The embodiment of the invention is not, however, limited to this and may be an embodiment wherein the access permission range is set, as the initial setting, to the security setting guide server 6 and to the virus information server 5, and the access permission range is, when the security level of the terminal reaches the predetermined level, changed to the whole range. Namely, for actualizing this embodiment, the security management device 10 may be constructed as follows.

First, the method by which the security detection unit 11 of the security management device 10 detects the security level of the terminal 2, is the same as in the preceding embodiment.

The judging unit 12, in the case of having an access from the terminal 2, judges whether or not the security level of the terminal 2 reaches the predetermined security level. This judging method is also the same as in the preceding embodiment.

Then, in a case where the judging unit 12 judges that the security level of the terminal 2 reaches the predetermined security level, viz., in the case of judging that it is the object for the access permission, the access control unit 13 changes the access permission range to the whole range (all the computers) from the security setting guide server 6 and the virus information server 5 that have been set as the initial setting, and performs the routing so that this terminal 2 becomes accessible to whichever computer.

While on the other hand, in a case where the judging unit 12 judges that the security level of the terminal 2 does not reach the predetermined security level, i.e., in the case of judging that it is not the object for the access permission, the access control unit 3 sets the access permission range unchanged to the security setting guide server 6 and the virus information server 5 that have been set as the initial setting. The process, in which the access control unit 3 thereafter changes the security level of the terminal, is the same as in the preceding embodiment.

Further, in the embodiment, as the method by which the security detection unit 11 detects the security level, the detection is made based on whether or not the terminal 2 accesses at the predetermined interval the server 5 (which is the access pattern), however, without being limited to this, the security level may also be detected, the security management device 1 recording an access history of the terminal 2, by use of this access history.

For instance, in case the terminal 2 accesses other computer, the security management device 1 receives a data packet transmitted from the terminal 2 and records, as an access history, a destination address and a source address (the address of the terminal 2) that are contained in the data packet and date/time information about when the data packet was received.

Then, in case there is the access request to other computer from the terminal 2, the latest date/time when the terminal 2 has accessed the virus information server 5, is obtained from the access history, and the security level may be detected in such a way that the security level is to be low if the latest date/time of this access is anterior to a predetermined date/time and is to be high if posterior to the predetermined date/time.

What is claimed is:

1. A security management device including:
a security detection unit detecting a security level of a apparatus;
a judging unit judging by comparing the security level of the apparatus with a predetermined level; and
an access control unit, in case the judging unit judges that the security level of the apparatus does not reach the predetermined level, restricting an access permission range of the apparatus.

2. A security management device according to claim 1, wherein the access control unit, in case the judging unit judges that the security level of the apparatus reaches the predetermined level, sets a range wider than the restriction range as the access permission range of the apparatus.

3. A security management device according to claim 1, wherein the access control unit has a function of selecting a communication route of the apparatus and, in case the judging unit judges that the security level of the apparatus does not reach the predetermined level, changes a communication destination of the apparatus to a specified device.

4. A security management device according to claim 3, wherein the specified device sets the security level of the apparatus or provides a setting guide to the apparatus.

5. A security management method by which a computer executes the steps of:
detecting a security level of a apparatus;
judging by comparing the security level of the apparatus with a predetermined level; and
in the case of judging that the security level of the apparatus does not reach the predetermined level, restricting an access permission range of the apparatus.

6. A security management method according to claim 5, including a step of, in the case of judging that the security level of the apparatus reaches the predetermined level, setting a range wider than the restriction range as the access permission range of the apparatus.

7. A security management method according to claim 5, wherein in case the step judges that the security level of the apparatus does not reach the predetermined level, in the step of restricting the access permission range of the apparatus, a communication destination of the apparatus is changed to a specified device.

8. A security management method according to claim 7, wherein the specified device sets the security level of the apparatus or provides a setting guide to the apparatus.

9. A recording medium recorded with a security management program for making a computer execute step of:
detecting a security level of a apparatus;
judging by comparing the security level of the apparatus with a predetermined level; and
in the case of judging that the security level of the apparatus does not reach the predetermined level, restricting an access permission range of the apparatus.

10. A recording medium recorded with a security management program according to claim 9, including a step of, in the case of judging that the security level of the apparatus reaches the predetermined level, setting a range wider than the restriction range as the access permission range of the apparatus.

11. A recording medium recorded with a security management program according to claim 9, wherein in case the step judges that the security level of the apparatus does not reach the predetermined level, in the step of restricting the access permission range of the apparatus, a communication destination of the apparatus is changed to a specified device.

12. A recording medium recorded with a security management program according to claim 11, wherein the specified device sets the security level of the apparatus or provides a setting guide to the apparatus.

13. A security management system configured by connecting a security management device, a apparatus for a user and a security setting guide device via a network, including:
a security detection unit detecting a security level of a apparatus;
a judging unit judging by comparing the security level of the apparatus with a predetermined level; and
an access control unit, in case the judging unit judges that the security level of the apparatus does not reach the predetermined level, restricting an access permission range of the apparatus.

14. A security management system according to claim 13, wherein the access control unit, in case the judging unit judges that the security level of the apparatus does not reach the predetermined level, has the apparatus connected to the security setting guide device.
